(19) United States
(12) Patent Application Publication
(10) Pub. No.: US 2004/0143790 A1
(43) Pub. Date: Jul. 22, 2004

(54) Method for creating web form

(75) Inventors: Lien Chun Ding, Taoyuan (TW); Ching Kang Lee, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: EC-Serve.com., INC., Taipei (TW)

(21) Appl. No.: 10/430,202

(22) Filed: May 6, 2003

(30) Foreign Application Priority Data
Jan. 17, 2003 (TW) 092101052

(51) Int. Cl. G06F 15/00

(52) U.S. Cl. 715/506

(57) ABSTRACT

The present invention discloses a method for creating a web form, including steps of providing a database having a plurality of modules, selecting a specific module from the database, providing the specific module with a format for outputting the form.

### FIELD OF THE INVENTION

This invention relates to a method for creating a form, and more particularly to a method for creating a web form.

### BACKGROUND OF THE INVENTION

The computer technology is very popular nowadays. The computer applications are not only for text treatment but also for further uses in many enterprises. For example, all the computers are connected in the network and through the usage of web forms to shorten the work processes. Or the application of database and communication mechanism is built in the network.

But in the current process of creating web forms, the problems like the complication of creating varieties of the form and too many steps to follow for data input still exist. For this, this present invention develops the following technology to solve these problems found in the practical use. Based on this, this software reasonably uses the web format, simplifies the work process and breaks through the traditional design concept to provide the users the simple front-end operating interface. Although the complicated logic calculation is contained inside the software, this is an user-friendly software which satisfies the most public end users.

Please refer to FIG. 1, it lists the differences between the form design of the prior-art and that of this present invention. And the table 1 shows the advantages and disadvantages.

TABLE 1

| | | Form designed by form |
|---|---|---|
| Item | Normal Form | wizard |
| Professional web page | Yes | No |
| designer | | |
| Required knowledge | Html, Css and | mouse and keyboard usage |
| | professional tools | |
| Can be modified or not | No (Need to | Yes (Users can do that any |
| | redesign the form.) | time.) |
| Personalized or not | Decided by designer | As users wish (including |
| | | finished module) |
| Durability | Short | Long |
| Cost | Expensive | Cheap |

Because of the technical defects according to prior arts, the applicant keeps on carving unflaggingly to develop a “method for creating web form” through wholehearted experience and research.

### SUMMARY OF THE INVENTION

It is an object of the present invention to provide a method for simplifying the work process of the web form creation, broadcast the important information on the network quickly and increase the work productivity.

It is anther object of the present invention to provide the users the simple front-end operating interface.

In accordance with an aspect of the present invention to provide a method for creating a form, including steps of (a) providing a database having a plurality of modules, (b) selecting a specific module from the database, and (c) providing the specific module with a format for outputting the form.

Preferably, the form is a web form.

Preferably, the step (b) further includes a step of defining a form title for the specific module.

Preferably, each of the plurality of modules has a form type and an item number.

Preferably, the specific module is selected according to the form type.

Preferably, the specific module is selected according to the item number.

Preferably, the format is defined according to the item number.

Preferably, the specific module includes at least an item.

Preferably, the format is defined according to the form type.

Preferably, the step (c) further includes a step (c1) of opening a dialog box for inputting a new form type if the new form type is not found in a form type list for the modules.

Preferably, the step (c) further includes a step (d) of displaying the web form.

It is an object of the present invention to provide a method for creating a web form from a database having plural modules, including steps of (a) selecting a specific module from the database, and (b) inputting a format, and (c) outputting the web form from the specific module according to the format.

Preferably, the step (b) further includes a step of defining a form title for the specific module.

Preferably, each of the plurality of modules has a form type and an item number.

Preferably, the specific module is selected according to the form type.

Preferably, the specific module is selected according to the item number.

Preferably, the format is defined according to the item number.

Preferably, the specific module includes at least an item.

Preferably, the format is defined according to the form type.

Preferably, the step (c) further includes a step (c1) of opening a dialog box for inputting a new form type if the new form type is not found in a form type list for the modules.

Preferably, the step (c) further includes a step (d) of displaying the web form.

The present invention may best be understood through the following description with reference to the accompanying drawings, in which:

### BRIEF DESCRIPTION OF THE DRAWINGS

FIG. 1 shows the flow chart of form creation process for the prior art and the present invention;

FIG. 2 shows the operating process of the method for creating a web form method according to a preferred embodiment of the present invention;

FIG. 3 shows the system correlation diagram of the method for creating a web form according to a preferred embodiment of the present invention; and

FIGS. 4(a) to (c) show the operating process diagrams according to a preferred embodiment of the present invention.

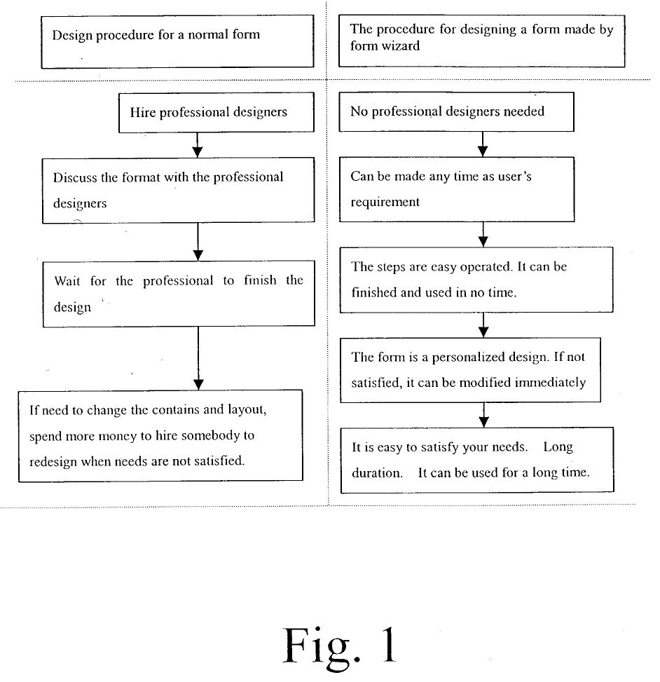

### DETAILED DESCRIPTION OF THE PREFERRED EMBODIMENT

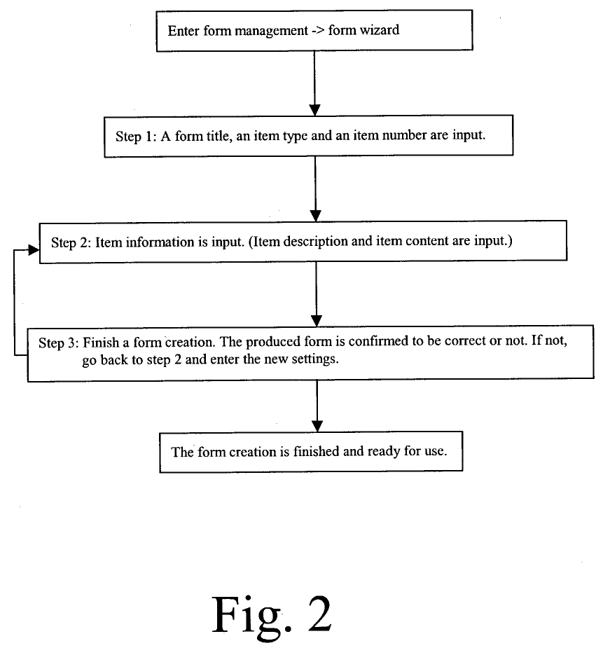

The present invention provides a method for creating a web form. The procedure is shown in FIG. 2. While design and input the form, based on information from the client, this software will supply the friendly interface. Like some registration form, it only needs 3 steps to finish creating a form. This will reduce lots of troubles for the MIS people to design a form. And the users can use the database easily. The results can be displayed in Excel format, which will make the web registration easily managed.

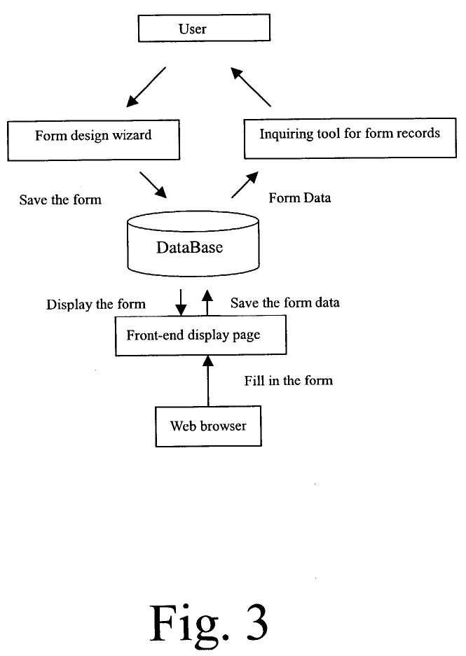

As for the structure, this software is the key point for the whole system. It is like the bridge connecting the system users and the web browsers. FIG. 3 shows the relationship between them.

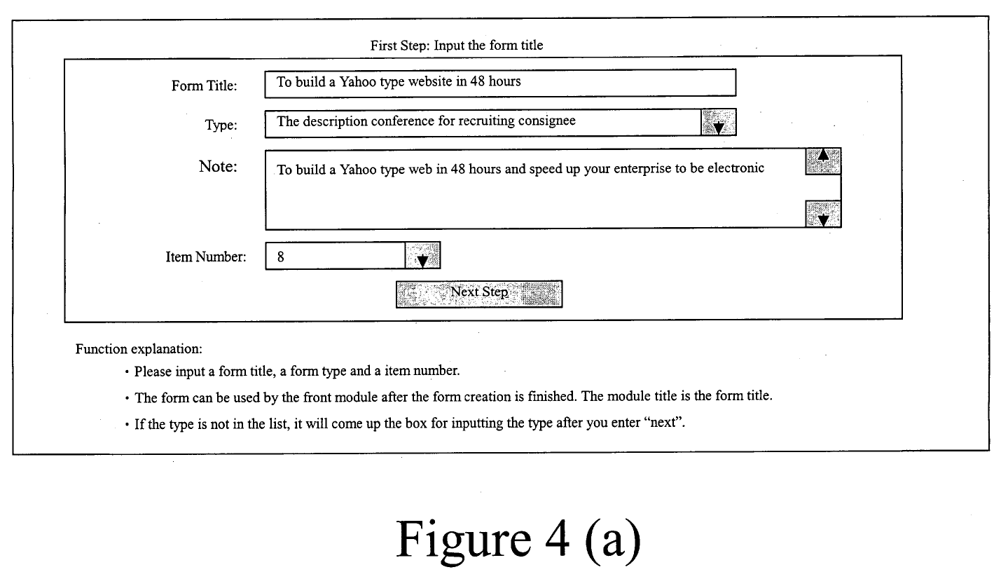

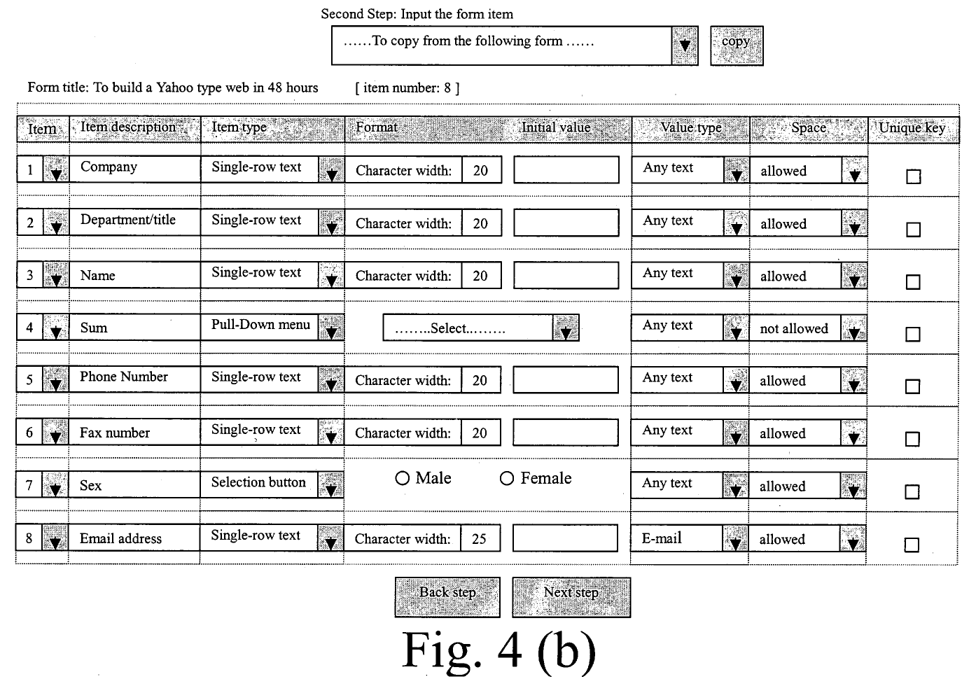

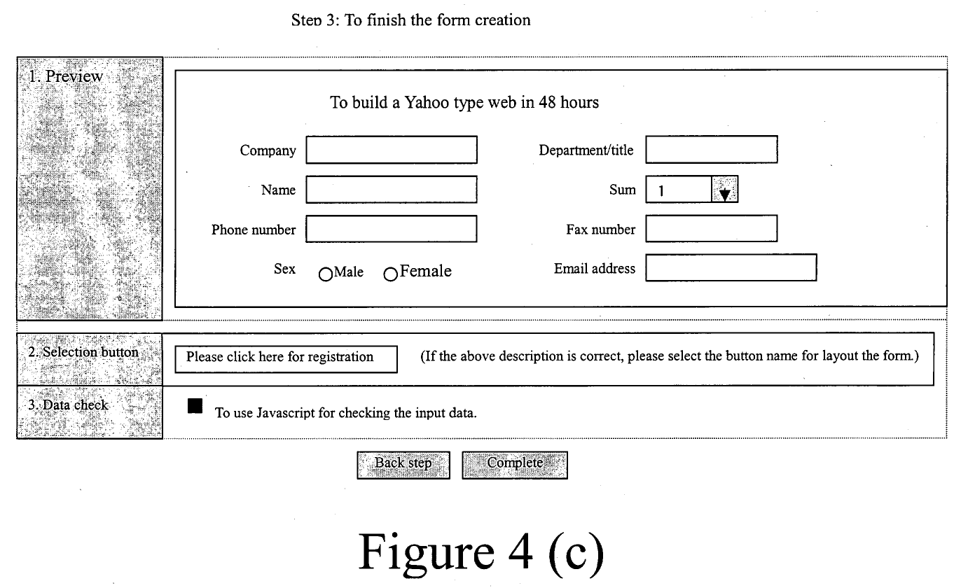

The present invention provides the real example for the operating procedure, please refer to FIG. 4(a) to FIG. 4(c). First, as shown in FIG. 4(a), the user inputs all the items for the form via form wizard. After the user confirms the output of the form, this program will produce the HTML codes and store all the definitions of all the items and the HTML codes for displaying the form to a table. This table which is treated as the parameter database of the form can provide the flexibility for the future possible modification for the form. From FIG. 4(b), according to the definition of each item, the software produces the particular table in the database for this form to store all the input information of the form. The user doesn't require any basic database knowledge as this process is automatic proceeded. Last, according to FIG. 4(c), it will directly generate a preview right after the form is done. And according to the definition of the form, the legality of the input data will be checked while the user inputs the information of the form. The legal input data for the form will be stored in the table for further inquiry.

Besides, after finishing the task of creating the form, the screen will show four selections for the advanced settings, “Modification for form display”, “Send response message”, “Form creating program” and “Front page screen setting”. “Modification for form display” is to fine-tune the automatically produced form, adjust the ratio for the display on the form and preview the form on line by using simple HTML language through html-editor. “Send response message””is to send user a “Thank you” message after the user finishing the task of filling data. “Form creating program” is to continue creating another new form for linking other work. “Front page screen setting” is the operation to put the finished form to the front-page.

To sum up the above explanation and demonstration, this invention of this form design program is to simplify the work process, broadcast the important information on the network quickly and increase the work productivity. No others are comparable to this new technology in the field of easy use. The purpose of this invention is to make the normal end users easily produce the web pages which are expected from the professional. The form can be completed by three steps and the “form design program” uses the browser as the only interface and requires no setting on the user side.

So the present invention is creative, original and advanced. Besides meeting the requirement for the current industries, the present invention also provides the new technology to eliminate the disadvantage of the older technology. So the present invention really has the value of the practical development.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for creating a form, comprising steps of:
(a) providing a database having a plurality of modules;
(b) selecting a specific module from said database; and
(c) providing said specific module with a format for outputting said form.

2. The creating method as claimed in claim 1, wherein said form is a web form.

3. The creating method as claimed in claim 1, wherein said step (b) further comprises a step of defining a form title for said specific module.

4. The creating method as claimed in claim 1, wherein each of said plurality of modules has a form type and an item number.

5. The creating method as claimed in claim 4, wherein said specific module is selected according to said form type.

6. The creating method as claimed in claim 4, wherein said specific module is selected according to said item number.

7. The creating method as claimed in claim 4, wherein said format is defined according to said item number.

8. The creating method as claimed in claim 4, wherein said specific module comprises at least an item.

9. The creating method as claimed in claim 4, wherein said format is defined according to said form type.

10. The creating method as claimed in claim 1, wherein said step (c) further comprises a step (c1) of opening a dialog box for inputting a new form type if said new form type is not found in a form type list for said modules.

11. The creating method as claimed in claim 1, wherein said step (c) further comprises a step (d) of displaying said web form.

12. A method for creating a web form from a database having plural modules, comprising steps of:
(a) selecting a specific module from said database; and
(b) inputting a format; and
(c) outputting said web form from said specific module according to said format.

13. The creating method as claimed in claim 12, wherein said step (b) further comprises a step of defining a form title for said specific module.

14. The creating method as claimed in claim 12, wherein each of said plurality of modules has a form type and an item number.

15. The creating method as claimed in claim 14, wherein said specific module is selected according to said form type.

16. The creating method as claimed in claim 14, wherein said specific module is selected according to said item number.

15. The creating method as claimed in claim 14, wherein said format is defined according to said item number.

16. The creating method as claimed in claim 14, wherein said specific module comprises at least an item.

17. The creating method as claimed in claim 14, wherein said format is defined according to said form type.

18. The creating method as claimed in claim 12, wherein said step (c) further comprises a step (c1) of opening a dialog box for inputting a new form type if said new form type is not found in a form type list for said modules.

19. The creating method as claimed in claim 11, wherein said step (c) further comprises a step (d) of displaying said web form.
